(19) United States
(12) Patent Application Publication
(10) Pub. No.: US 2006/0060014 A1
(43) Pub. Date: Mar. 23, 2006

(54) Ball screw device for steering system

(75) Inventor: Joo Namgung, Wonju-si (KR)

Correspondence Address: R. Neil Sudol, 714 Colorado Avenue, Bridgeport, CT, 06605-1601, US

(73) Assignee: Mando Corporation, Pyungtaek-si (KR)

(21) Appl. No.: 10/943,479

(22) Filed: Sep. 17, 2004

(51) Int. Cl. F16H 25/22

(52) U.S. Cl. 74/89.23

(57) ABSTRACT

The present invention relates to a ball screw device of a steering system having a damper, comprising a ball screw that is movable in an axial direction and has a spiral outer groove on an outer surface of the same; a ball nut that has an inner groove opposite to an outer groove of the ball screw; a plurality of balls that are inserted between the outer groove and the inner groove so that the ball nut is thread-engaged with the ball screw; and a damper that is installed between an inner surface of the ball nut and an outer surface of the ball screw for thereby decreasing noises and vibrations. It is possible to decrease noises and vibrations between an outer surface of the ball screw and an inner surface of the ball nut thread-engaged with the ball screw by disposing a plurality of balls.

### BACKGROUND OF THE INVENTION

1. Field of the Invention

The present invention relates to a ball screw device for a steering system in which a damper is installed at a ball nut in order to decrease vibrations and noises occurring from a plurality of balls adapted for a ball nut and a ball screw during an operation of a ball screw device.

2. Description of the Background Art

The conventional ball screw device in an electric power steering system will be described.

In the electric power steering system, a return structure is provided in a ball nut so that a rolling ball is circulated. There are a deflector type (inner circulation method) having a return guide piece in the interior of a ball nut, a return tube type (outer circulation method) having a return tube in an outer side of a ball nut, and an end cap type in which a circulation is achieved through an end cap installed at one end of the same.

FIG. 1 is a cross sectional view illustrating a conventional ball screw device of a deflector type having a return guide piece wherein balls are circulated in the interior. As shown therein, a spiral outer groove 12 is formed on an outer surface of a longitudinal ball screw.

In addition, a ball nut 13 has hollow cylindrical shape and the ball nut 13 is installed in an outer side of a ball screw 11 in such a manner that a spiral inner groove 14 is formed on an inner surface of the ball nut 13 for thereby being contacted with an outer groove 12 of a ball screw. A plurality of steel balls 10 are inserted between the outer groove 12 and the inner groove 14 each having a semicircular cross section, and the return guide piece 18 in which balls 10 are circulated is formed on one side of inner part of the ball nut 13.

In the conventional ball screw device, when an external rotational force is transferred to the ball nut 13 for the rotation of the same, the balls 10 roll along the outer groove 12 and the inner groove 14 and push a shaft 1 having the ball screw 11 and are circulated by the return guide piece 18.

However, in the conventional ball screw device, there is not any device for decreasing the vibrations and noises occurring due to a rolling operation of the balls 10 adapted for a smooth operation of the ball nut 13 and the ball screw 11 of the shaft. The vibrations and noises are directly transferred to a driver, so that the performance of a vehicle is decreased. In addition, the durability of a vehicle is significantly decreased.

### SUMMARY OF THE INVENTION

Accordingly, it is an object of the present invention to overcome the problems encountered in the conventional art.

It is another object of the present invention to provide a ball screw device having a damper supporting a ball screw for enhancing the performance of a vehicle by decreasing the noises and vibrations occurring during an operation of a ball screw device.

To achieve the above objects, there is provided a ball screw device of a steering system having a damper, comprising a ball screw that is movable in an axial direction and has a spiral outer groove on an outer surface of the same; a ball nut that has an inner groove opposite to an outer groove of the ball screw; a plurality of balls that are inserted between the outer groove and the inner groove so that the ball nut is thread-engaged with the ball screw; and a damper that is installed between an inner surface of the ball nut and an outer surface of the ball screw for thereby decreasing noises and vibrations.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a conventional ball screw device of a deflector method having a return guide piece;

FIG. 2 is a cross sectional view illustrating a conventional rack type electric power steering system;

FIG. 3 is a cross sectional view illustrating a ball screw device having a damper configured to support a groove of a ball screw at the both ends of a ball nut;

FIG. 4 is a cross sectional view illustrating a ball screw device having a damper configured to support a groove of a ball screw at one side end of a ball nut according to the present invention;

FIG. 5 is a cross sectional view illustrating a ball screw device having a damper configured to support a thread of a ball screw at the both ends of a ball nut according to the present invention;

FIG. 6 is a cross sectional view illustrating the interior of a ball nut by cutting a part of a ball nut having a damper configured to support a groove of a ball screw according to the present invention;

FIG. 7 is a cross sectional view illustrating the interior of a ball nut by cutting a part of a ball nut having a damper configured to support a thread of a ball screw according to the present invention; and

FIG. 8 is a perspective view illustrating a damper shown by separating a damper installed at a ball nut from a ball nut according to the present invention.

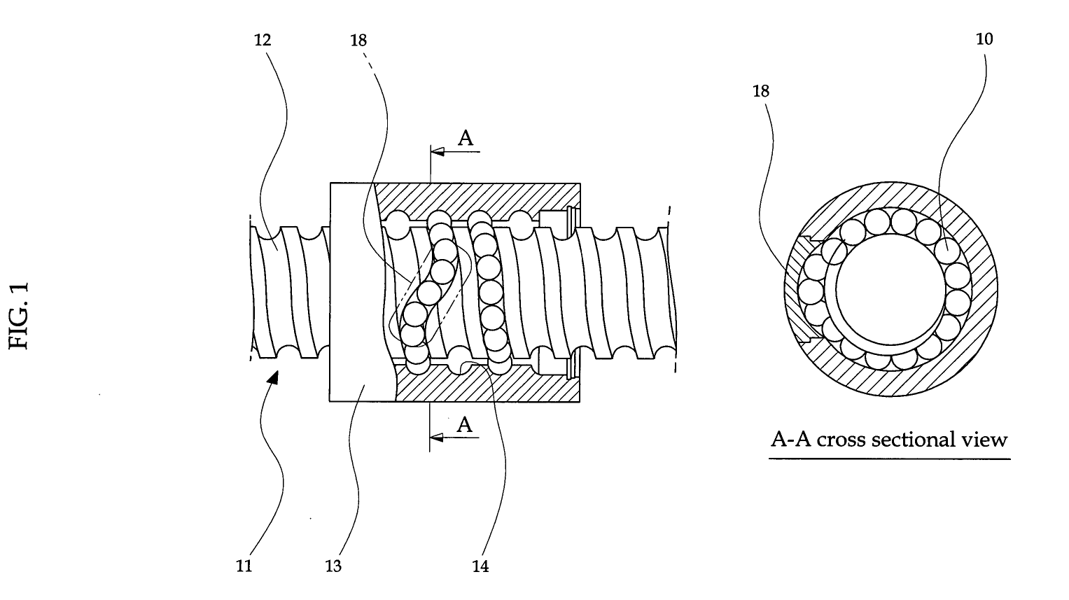

### DETAILED DESCRIPTION OF THE PREFERRED EMBODIMENTS

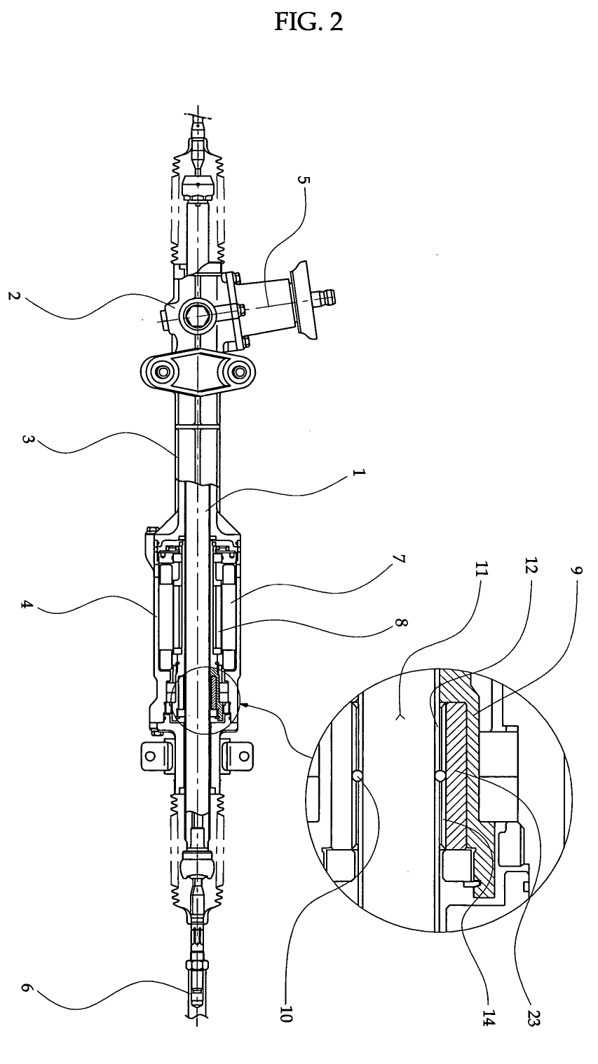

The preferred embodiments of the present invention will be described with reference to the accompanying drawings. The same elements as the construction of the conventional art will be given the same element names and numerals. FIG. 2 is a cross sectional view illustrating a R-EPS (Rack Assist Type—Electric Power Steering System) of a coaxial type to which a ball screw device is adapted.

As shown in FIG. 2, the rack driven type electric power steering device includes a shaft 1 that linearly reciprocates in the interior of an outer casing, a pinion installed at a lower end of a handle shaft 5 at a rear side of the shaft, and a rack (not shown) engaged with the pinion and adapted to move the shaft 1 in an axial direction. Here, the rotation of a steering wheel is converted into an axial linear movement of the shaft 1 by a rack and pinion gear 2. The shaft 1 includes a ball screw 11 on an outer surface far from the rack.

The rack is received in the hollow rack housing 3 that is elongated in the left and right directions at one side of the shaft 1. A motor is installed for a steering force for thereby achieving an efficient operation of the rack. At this time, the motor housing 4 forming an outer construction of the motor is connected with the rack housing 3.

A stator 7 is closely installed at an inner surface of the motor housing 4. A rotor 8 is installed in the interior of the same. A motor shaft 9 is installed in the interior of the rotator with disposed bearings.

A ball screw device is installed in the interior of the motor shaft 9. The ball screw device includes a ball nut 23 installed at an inner end portion of the motor shaft 9, a ball screw 11 inserted into the interior and moving in an axial direction, and a ball 10 inserted between the ball nut 23 and the ball screw 11.

In the present invention, a ball screw device according to the present invention is adapted to a rack driven type electric power steering system. Therefore, in the present invention, it is possible to prevent the vibrations and noises from the ball screw device that occurs when the shaft is moved in an axial direction in response to a manual steering force for thereby preventing a decrease of steering feeling.

The damper according to the present invention could be installed at the coaxial R-EPS as well as the non-coaxial type R-EPS in which the shaft of the motor is installed at an inclination with respect to the shaft 1.

The construction of the ball screw device according to the present invention will be described with reference to the accompanying drawings.

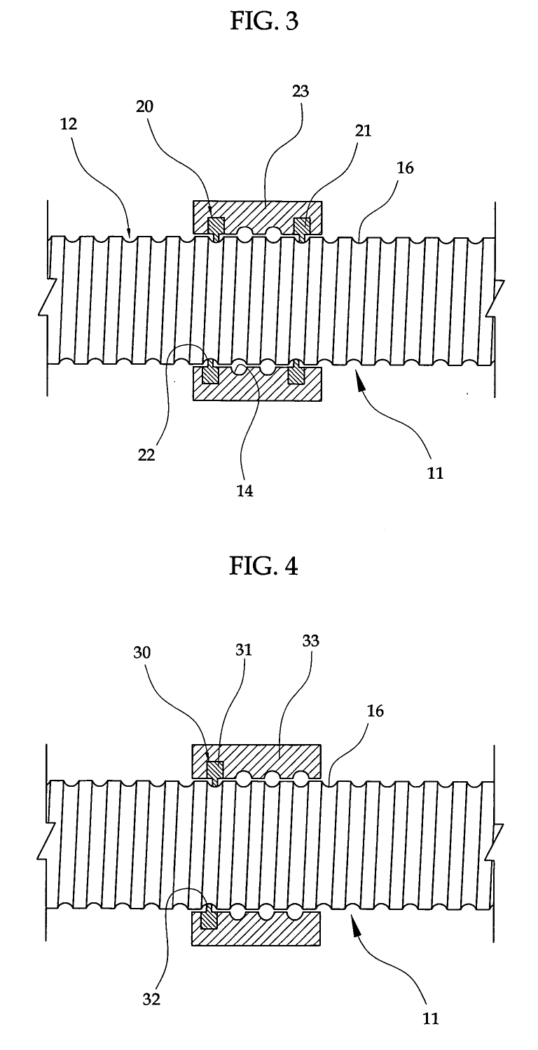

FIG. 3 is a view illustrating the ball screw device. Namely, there is shown a ball screw device having a damper 20 adapted to support a groove 16 of a ball screw at the both sides of the ball nut 23. As shown in FIGS. 2 and 3, the ball screw 11 is constructed with the shaft as one body at one side of the shaft 1 far from the rack and has a screw shaped outer groove 12 on an outer surface of the same.

In addition, a hollow ball nut 23 is installed at an outer portion of the ball screw 11 and is rotatable for helping an axial movement of the shaft. An inner groove 14 is extended in a spiral shape at an inner surface of the ball nut 23 and corresponds to the outer groove 12 of the ball screw 11. A plurality of steel balls 10 are inserted between the outer groove 12 with a semicircular cross section and the inner groove 14.

In the ball screw device, when an external rotational force is transferred to the ball nut 23 for thereby rotating the same, the balls 10 roll and move the shaft 1 in an axial direction.

The damper 20 formed of a PTFE (Polytetrafluoroethylene) is installed at the ball nut 23 for thereby supporting the ball screw 11 at a right angle with respect to the shaft 1, so that the vibrations and noises occurring due to the rolling of the balls 10 are effectively prevented.

A hair band shaped damper 20 is installed at the both ends of the ball nut 23 for thereby supporting a groove 16 that is a concave portion corresponding to the center of the outer groove 12 of the ball screw 11, so that it is possible to prevent the noises occurring during the rolling of the balls 10 and the vibrations in the axial direction of the shaft 1 or in the vertical direction of the shaft 1.

In the present invention, the damper according to the present invention is installed at the ball nut 23. The protrusion 22 corresponding to an upper end of the protruded damper 20 is preferably rounded for supporting the groove 16 of the ball screw and damping.

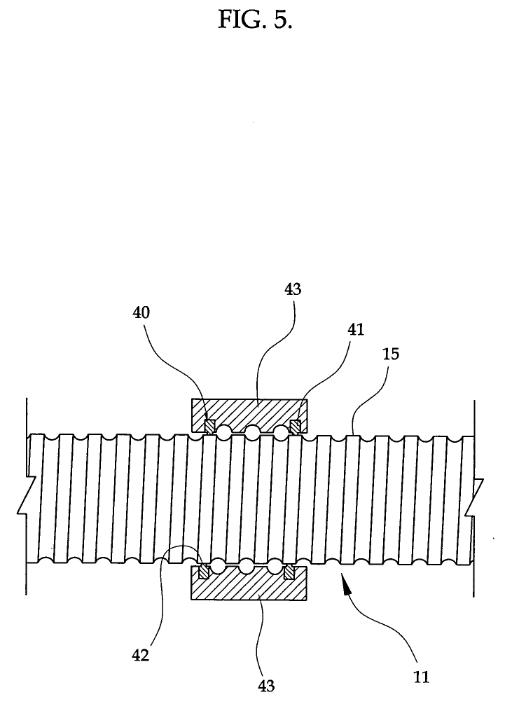

As shown in FIG. 4, the damper 30 according to the present invention is installed at one end of the ball nut 33 for thereby supporting the groove 16 of the ball screw. FIG. 3 shows the operation of the same.

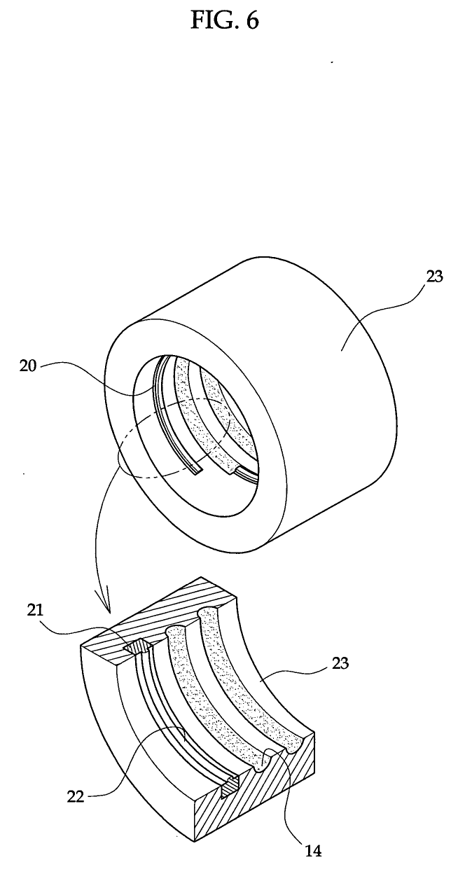

FIG. 5 is a view of another embodiment of the present invention. Namely, in this embodiment, a damper 40 is installed at the both ends of the ball nut 43 for thereby supporting the thread 15 of the ball screw corresponding to the threads of a screw. Therefore, it is possible to prevent the noises occurring during the rolling of the balls 10 and the vibrations in the vertical direction of the shaft 1. In this case, the damper is installed at one side of the ball nut 43 and supports the thread 15 of the ball screw and does damping operation.

Here, the protrusion 42 of the damper 40 supporting the thread 11 of the ball screw may be rounded like the groove 16 is supported. However, in this embodiment, the protrusion 42 of the damper 40 is preferably formed in a flat shape.

The construction of the ball nut having a damper according to the present invention will be described with reference to the accompanying drawings.

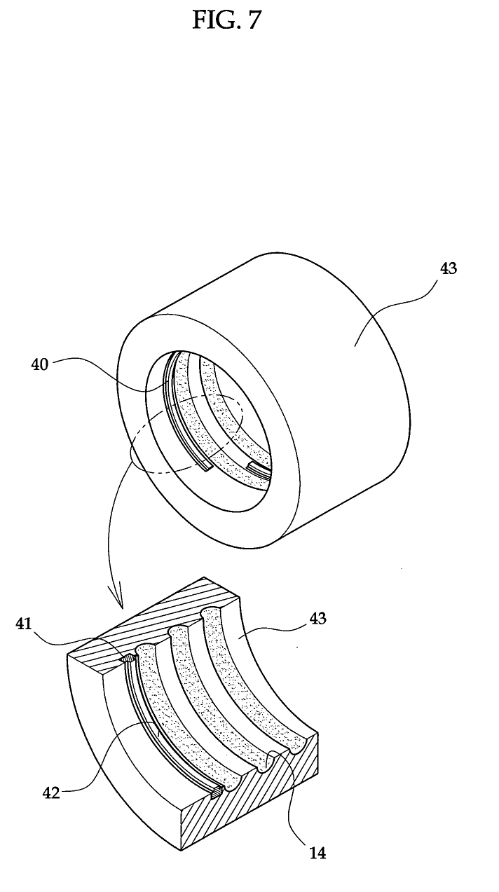

FIG. 6 is a cross sectional view illustrating the interior of the ball nut by cutting a part of the ball nut having a damper adapted to support the groove 16 of the ball screw. As shown therein, a groove in which the damper is installed is elongated at an end portion of the inner groove 14 of the ball nut having the damper 20 adapted to support the groove 16 of the ball screw. At this time, the elongated groove is formed in an angular shape for example a rectangular shape unlike the semicircular inner groove 14 for preventing the damper 20 from being separated from the ball nut 23.

The engaging part 21 of a lower side of the protruded damper 20 is received at the elongated groove of the inner groove 14 of the ball nut and is not escaped from the ball nut 23. The protrusion 22 of an upper side of the protruded damper 20 supports the groove 16 of the ball screw for thereby decreasing vibrations occurring from the ball screw device.

FIG. 7 is a cross sectional view illustrating the interior of a ball nut by cutting a part of the ball nut 43 having a damper 40 adapted to support the thread 15 of the ball screw according to the present invention. A groove formed in an angular shape for example a rectangular shape is provided between the inner grooves 14 of the ball nut 43 and the groove for installing the damper 40 therein at the end of the inner groove 14 of the ball nut wherein the damper 40 is adapted to support the thread of the ball screw is different from the construction of FIG. 6 that shows a cross section of the interior of the ball nut 23 supporting the groove 16.

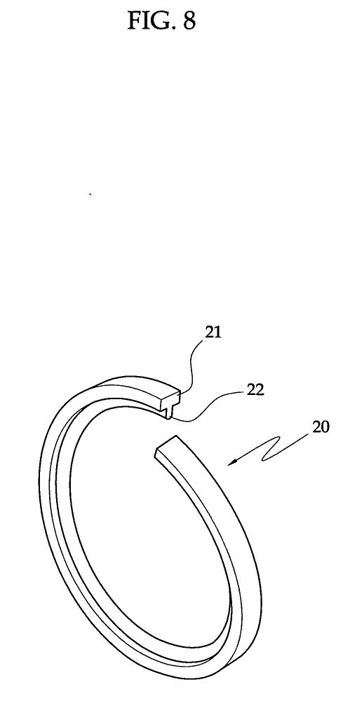

FIG. 8 is a perspective view illustrating the dampers 20 and 30 supporting the groove of the ball screw. A hair band shaped damper is installed at the ball nut with a certain length corresponding to one pitch from one end of the ball nut. At this time, the both ends of the damper are distanced by one pitch for thereby corresponding to the construction of the ball nut in which the damper is installed.

As described above, in the ball screw device of the steering system according to the present invention, a damper formed of a synthetic resin material is installed at the both sides or at one side of the ball nut for thereby supporting the groove or thread of the ball screw, so that it is possible to decrease the vibrations and noises occurring during the rolling of the balls and to enhance the reliability of the products.

In addition, in the present invention, it is possible to decrease the vibrations and noises and to increase the durability as compared to the ball screw device that does not include the damper.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A ball screw device of a steering system having a damper, comprising:
a ball screw that is movable in an axial direction and has a spiral outer groove on an outer surface of the ball screw;
a ball nut that has an inner groove opposite to the outer groove of the ball screw;
a plurality of balls that are inserted between the outer groove and the inner groove so that the ball nut is thread-engaged with the ball screw; and
a damper that is installed between an inner surface of the ball nut and an outer surface of the ball screw for thereby decreasing noises and vibrations.

2. The device of claim 1, wherein said damper supports the ball screw at one side of the ball nut.

3. The device of claim 1, wherein said damper supports the ball screw at the both ends of the ball nut.

4. The device of claim 1, wherein said damper supports the groove of the ball screw.

5. The device of claim 1, wherein said damper supports the thread of the ball screw.

6. The device of claim 1, wherein said damper is formed of a synthetic resin material.

7. The device as in one of claims 1-6, wherein said ball nut has a groove angular at an inner surface of the ball nut so that the damper is installed and is not escaped from the ball nut.
